(19) United States
(12) Patent Application Publication
(10) Pub. No.: US 2013/0231837 A1
(43) Pub. Date: Sep. 5, 2013

(54) ELECTRONIC CONTROL OF A LIMITED SLIP DIFFERENTIAL

(71) Applicants: James H. Holbrook, Fenton, MI (US); Michael P. Turski, Rochester Hills, MI (US)

(72) Inventors: James H. Holbrook, Fenton, MI (US); Michael P. Turski, Rochester Hills, MI (US)

(73) Assignee: GM GLOBAL TECHNOLOGY OPERATIONS LLC, Detroit, MI (US)

(21) Appl. No.: 13/410,562

(22) Filed: Mar. 2, 2012

(51) Int. Cl. F16H 48/34

(52) U.S. Cl. 701/69

(57) ABSTRACT

A method for regulating an electronic limited slip differential (eLSD) to apportion generated drive torque between first and second road wheels includes determining maximum torque capability of each wheel to identify more and less capable wheels. The method also includes determining a remaining portion of the drive torque by subtracting the maximum torque capability of the less capable wheel from the generated torque. The method additionally includes transferring to the more capable wheel a portion of the drive torque that is equal to the torque capability of the more capable wheel if the remaining portion is greater than the torque capability of the more capable wheel. Furthermore, the method includes transferring to the more capable wheel the remaining portion of the drive torque if the remaining portion is equal to or less than the torque capability of the more capable wheel. A vehicle employing the method is also disclosed.

### TECHNICAL FIELD

The invention relates to a system and a method for electronic control of a limited slip differential in a motor vehicle.

### BACKGROUND

A typical motor vehicle employs a differential to transmit torque and rotation from a power source such as an internal combustion engine, an electric motor, or a combination thereof to the vehicle's road wheels via individual output or axle shafts. A differential is a device that allows each of the driving road wheels to rotate at different speeds mainly when negotiating a turn.

During vehicle cornering, the vehicle's wheels that are on the inside relative to the turn generally travel a shorter distance than the wheels that are on the outside of the turn. Accordingly, during cornering without a differential a vehicle's inside wheel may end up spinning, while its outside wheel may end up dragging. Such a condition may result in difficult and unpredictable handling of the vehicle, damage to vehicle tires, and strain on and possible damage to the vehicle's drivetrain.

A standard or “open” differential tends to transmit a largely equivalent amount of torque to both drive wheels. However, in certain driving conditions, an open differential may transfer a majority of drive torque to a wheel that has been unloaded or experiences reduced frictional contact with the road. In such a situation, the unloaded or reduced frictional contact wheel may rotate freely, thus converting a substantial amount of drive torque into tire slip and not into powering the vehicle.

To counteract such a loss of effective drive torque, certain higher performance vehicles employ limited slip differentials (LSDs) that allow for some difference in angular velocity of the output shafts, but impose a mechanical restriction on such a disparity. Typically the mechanical restriction is provided via a frictional interface, for example with specially configured gears or clutching elements. By limiting the difference in angular velocity between the driven wheels, useful torque can be transmitted to the road surface, as long as some traction is generated by at least one of the driven wheels. In modern vehicles, electronically controlled LSDs are sometimes used for more precise apportionment of drive torque between the drive wheels.

### SUMMARY

A method is disclosed for regulating in a motor vehicle an electronic limited slip differential (eLSD) to apportion drive torque from a power source between first and second drive wheels and transmit the drive torque to a road surface. The method also includes determining maximum torque capability of each of the first and second drive wheels and identifying the wheel that is capable of transmitting a greater portion and the wheel that is capable of transmitting a lesser portion of the drive torque to the road surface. The method also includes determining a remaining portion of the drive torque by subtracting the determined maximum torque capability of the wheel capable of transmitting the lesser portion of the drive torque from the generated drive torque.

The method additionally includes regulating the eLSD to transfer to the wheel that is capable of transmitting the greater portion of the drive torque a portion of the drive torque that is equal to the maximum torque capability of the more capable wheel if the remaining portion of the drive torque is greater than the determined maximum torque capability of the more capable wheel. Furthermore, the method includes regulating the eLSD to transfer to the wheel that is capable of transmitting the greater portion of the drive torque the determined remaining portion of the drive torque if the remaining portion of the drive torque is equal to or less than the determined maximum torque capability of the more capable wheel.

The method may additionally include detecting, in real-time, changes in orientation of the vehicle relative to the road surface via at least one vehicle sensor to determine the maximum torque capability of each of the first and second drive wheels. According to the method, the at least one vehicle sensor may include a lateral acceleration sensor, a longitudinal acceleration sensor, and a yaw sensor. In such a case, the method may additionally include determining weight transfer between the first and second drive wheels in response to the received signals from the lateral acceleration, longitudinal acceleration, and yaw sensors to determine in real-time the maximum torque capability of each of the first and second drive wheels.

Each of the first and second drive wheels may include a pneumatic tire that establishes tractive effort with respect to the road surface. In such a case, the method may additionally include determining loading on each respective tire to determine in real-time a maximum tractive effort thereof in response to the determined weight transfer between the first and second drive wheels. According to the method, the determination of the tractive effort of each respective tire is determined via the “friction circle” concept as described herein according to physical properties of and a vertical load on the subject tire.

Each of the acts of determining the maximum torque capability of each of the first and second drive wheels, determining the remaining portion of the drive torque, regulating the eLSD, detecting in real-time changes in orientation of the vehicle, determining weight transfer between the first and second drive wheels, and determining loading on each respective tire may be accomplished via a controller.

The vehicle may additionally include a first wheel speed sensor configured to detect in, real-time, the rotational speed of the first drive wheel, and a second wheel speed sensor configured to detect, also in real-time, the rotational speed of the second drive wheel. In such a case, the method may additionally include receiving via the controller the detected rotational speeds from the respective first and second wheel speed sensors and generating feed-back control of the eLSD by comparing a desired difference in speeds of the first and second drive wheels with actual difference thereof via the controller.

The eLSD may include a friction plate clutch, while the controller may be additionally configured to regulate engagement of the clutch to apportion the drive torque between the first and second drive wheels.

Also disclosed is a vehicle that includes the described controller to perform the above method.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic illustration of a motor vehicle equipped with an electronic limited slip differential (eLSD) for apportioning drive torque between the vehicle's driven road wheels.

FIG. 2 is a diagram of a friction circle describing tractive effort of a tire mounted on a road wheel such as for the vehicle shown in FIG. 1.

FIG. 3 is a diagram of friction circles for each of the driven wheels and a change in the wheels' respective torque capabilities when the wheels are subject to dynamic weight transfer.

FIG. 4 is a flow chart illustrating a method of regulating the eLSD shown in FIG. 1.

### DETAILED DESCRIPTION

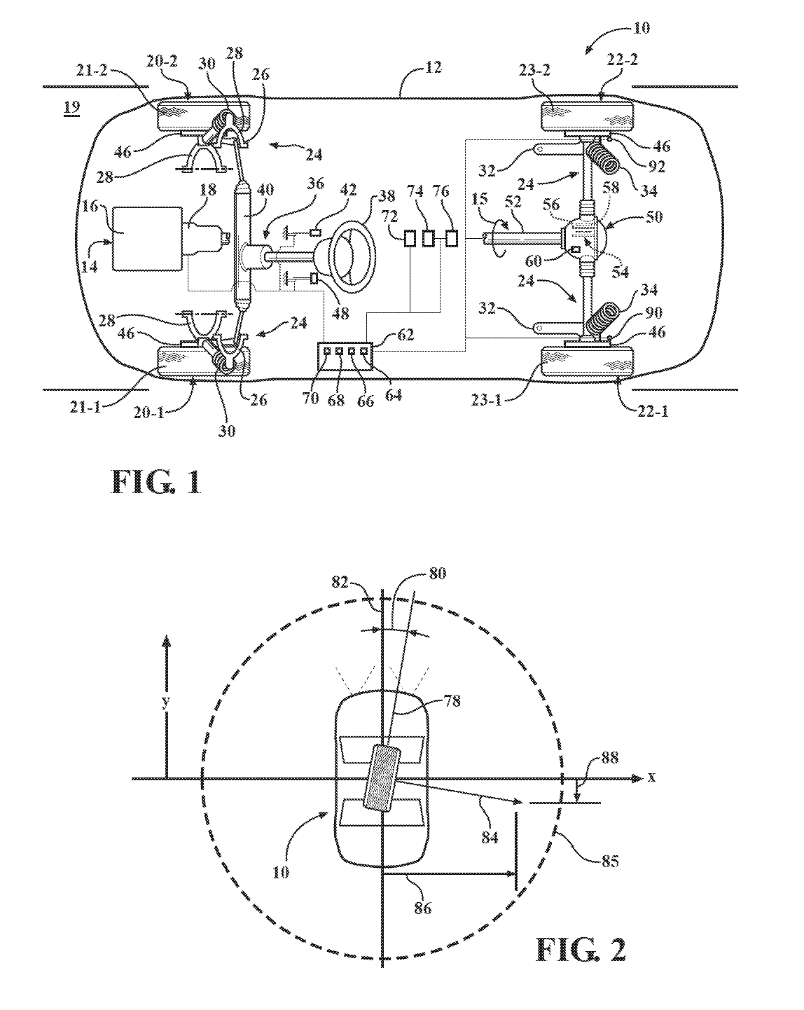

Referring to the drawings, wherein like reference numbers refer to like components, FIG. 1 shows a schematic view of a motor vehicle 10 which includes a vehicle body 12. The vehicle 10 also includes a power source 14 configured to generate drive torque 15 for propelling the vehicle. As shown in FIG. 1, the power source 14 is an engine 16 operatively connected to a transmission 18. The power source 14 may also include one or more motor/generators as well as a fuel cell, neither of which are shown, but a vehicle configuration employing such devices is appreciated by those skilled in the art.

The vehicle 10 also includes a plurality of wheels that include front wheels 20-1, 20-2 and rear wheels 22-1, 22-2. Although four wheels, 20-1, 20-2, 22-1, and 22-2 are shown in FIG. 1, a vehicle with fewer or greater number of wheels is also envisioned. As shown, the rear wheel 22-1 is a first drive wheel and the rear wheel 22-2 is a second drive wheel of the vehicle 10. The first and second drive wheels 22-1, 22-2 are rotated or driven by the power source 14 for transmitting the drive torque 15 generated by the power source 14 to a road surface 19 to motivate the vehicle 10 along the road surface. Although in the particular embodiment shown and described with respect to FIG. 1, the wheels 22-1, 22-2 are depicted as the vehicle drive wheels, in a different embodiment the front wheels 20-1, 20-2 may similarly be configured as the vehicle drive wheels. In yet another embodiment, all four wheels 20-1, 20-2, 22-1, and 22-2 may be configured to drive the vehicle 10 along the road surface 19. Additionally, each of the wheels 20-1, 20-2, 22-1, and 22-2 includes a respective pneumatic tire 21-1, 21-2, 23-1, and 23-2 mounted thereon.

As shown in FIG. 1, a vehicle suspension system 24 operatively connects the body 12 to the front and rear wheels 20, 22 for maintaining contact between the wheels 20-1, 20-2, 22-1, 22-2 and the road surface 19, and to maintain handling of the vehicle 10. The suspension system 24 may include an upper control arm 26, a lower control arm 28, and a strut 30 connected to each of the front wheels 20-1 and 20-2. The suspension system 24 may also include a trailing arm 32 and a spring 34 connected to each of the rear wheels 22-1 and 22-2. Although a specific configuration of the suspension system 24 is shown in FIG. 1, other vehicle suspension designs are similarly envisioned. The tires 21-1, 21-2, 23-1, and 23-2 establish a tractive effort with respect to the road surface 19 in response to the loading on each tire transmitted through the suspension system 24 during operation of the vehicle 10, as well as being affected by the friction coefficient between the tires and the particular road surface. The tractive effort of a tire is defined herein as the maximum grip available between the tire and the road surface 19, wherein such grip is dependent on the friction coefficient “μ” at the subject tire/road surface interface.

With continued reference to FIG. 1, a vehicle steering system 36 is operatively connected to the front wheels 20 for steering the vehicle 10. The steering system 36 includes a steering wheel 38 that is operatively connected to the wheels 20 via a steering rack 40. The steering wheel 38 is arranged inside the passenger compartment of the vehicle 10, such that an operator of the vehicle may command the vehicle to follow a particular path or assume a desired orientation with respect to the road surface 19. Additionally, an accelerator pedal 42 is positioned inside the passenger compartment of the vehicle 10, wherein the accelerator pedal is operatively connected to the power source 14 for commanding propulsion of the vehicle 10.

As shown in FIG. 1, a vehicle braking system is operatively connected to the wheels 20, 22 for decelerating the vehicle 10. The braking system includes a friction braking mechanism 46 at each of the wheels 20-1, 20-2, 22-1, and 22-2. Although not shown in detail, it will be appreciated that each braking mechanism 46 may include a rotor, brake pads, and calipers. The calipers may be configured to hold the brake pads relative to the rotors, and to apply a force to the brake pads in order to squeeze the rotors for decelerating the vehicle 10. The force applied by the braking system is controlled via a brake pedal 48. The brake pedal 48 is positioned inside the passenger compartment of the vehicle 10, and is adapted to be controlled by the operator of the vehicle 10.

As additionally shown in FIG. 1, the vehicle 10 also includes an electronic, i.e., electronically controlled, limited slip differential (eLSD) 50. The eLSD 50 is operatively connected to the power source 14 via a drive shaft 52, and is configured to apportion the drive torque 15 generated by the power source between the first and second drive wheels 22-1 and 22-2. The eLSD 50 is configured to limit the difference in angular velocity between the drive wheels 22-1 and 22-2 whenever one of the drive wheels becomes unloaded or otherwise loses traction. Accordingly, useful drive torque 15 can be transmitted to the road surface 19, as long as some traction is generated by at least one of the drive wheels 22-1, 22-2. The eLSD 50 may include a friction plate clutch 54 that is configured to apportion the drive torque 15 between the first and second drive wheels 22-1 and 22-2 in response to tractive effort and relative speeds of the tires 23-1, 23-2.

The clutch 54 may include friction plates 56 and drive plates 58 configured to be selectively engaged with each other for variable apportionment of the drive torque 15 between the drive wheels 22-1, 22-2. The friction plates 56 and drive plates 58 may be engaged with a selectable amount of force which may be applied either hydraulically or mechanically, such as via an electrically actuated hydraulic pump 60 or an electric motor (not shown), respectively. Accordingly, the selectable amount of force applied to engage friction plates 56 with drive plates 58 may be used to transfer a desired portion of the drive torque 15 from one of the drive wheels 22-1, 22-2 to the other.

As shown in FIG. 1, the vehicle 10 also includes a programmable controller 62 having a readily accessible long-term non-transient memory. The controller 62 is configured or programmed to regulate operation of the eLSD 50 to apportion the drive torque 15 between the first and second drive wheels 22-1, 22-2. To that end, the controller 62 may be configured to regulate the eLSD 50 such that initially the first and second drive wheels 22-1, 22-2 receive predetermined baseline portions 64 and 66, respectively, of the drive torque 15. The baseline portions 64 and 66 of the drive torque 15 to be transferred by the eLSD 50 will typically be preset at 50% for each drive wheel 22-1, 22-2. The controller 62 is also configured to determine maximum torque capability 68 of each of the first and second drive wheels 22-1, 22-2. The maximum torque capability of a wheel is herein defined as the maximum amount of engine-generated drive torque 15 that the subject wheel can transfer to the road surface 19 during a particular situation. Additionally, the controller 62 is programmed to identify the wheel that is capable of transmitting a greater portion, i.e., the more capable wheel, and the wheel that is capable of transmitting a lesser portion, i.e., the less capable wheel, of the drive torque 15 to the road surface 19.

The controller 62 is also configured to determine a remaining portion 70 of the drive torque 15 to be transferred to the specific drive wheel 22-1 or 22-2 that is capable of transmitting the greater portion of the drive torque. The determination of the remaining portion 70 of the drive torque 15 to be transferred to the more capable drive wheel 22-1 or 22-2 is accomplished by subtracting the determined maximum torque capability 68 of the wheel capable of transmitting the lesser portion of the drive torque from the generated drive torque 15. Additionally, the controller 62 will regulate the engagement of the friction plates 56 and drive plates 58 in the eLSD clutch 54 to transfer a portion of the drive torque 15 that is equal to the determined maximum torque capability of the more capable wheel 22-1 or 22-2 if the remaining portion 70 is greater than the determined maximum torque capability 68 of the more capable wheel. On the other hand, if the remaining portion 70 of the drive torque 15 is equal to or less than the determined maximum torque capability 68 of the more capable wheel 22-1 or 22-2, the controller 62 is programmed to regulate the eLSD 50 to transfer to the more capable wheel the determined remaining portion 70 of the drive torque 15. Additionally, the controller 62 may be configured as a central processing unit that is programmed to regulate operation of the power source 14 and the amount of drive torque 15 generated thereby.

As shown in FIG. 1, the vehicle 10 additionally includes vehicle sensors mounted on the vehicle body 12 and configured to detect in real-time g-forces and changes in orientation of the vehicle relative to the road surface 19. Generally, the g-forces sensed by such sensors may act on the vehicle 10 as a result of, and, therefore, be indicative of cornering, forward acceleration, and/or braking of the vehicle and the forces generated during such maneuvers. The vehicle 10 may employ a stability control system (not shown) and the subject sensors may be part of that system. The controller 62 is configured to receive signals from the vehicle sensors to determine the torque capability of each of the first and second drive wheels 22-1, 22-2. Such vehicle sensors may include a lateral acceleration sensor 72 configured to detect as the vehicle 10 moves laterally with respect to the road surface 19, a longitudinal acceleration sensor 74 that is configured to detect acceleration or deceleration of the vehicle along the centerline of the vehicle labeled as X, and a yaw sensor 76 configured to detect a yaw rate of the vehicle body 12.

In response to the received signals from the sensors 72, 74, and 76, and as the vehicle 10 performs various maneuvers, the controller determines dynamic weight transfer between the first and second drive wheels 22-1, 22-2. Such determination of the weight transfer between the first and second drive wheels 22-1, 22-2 in turn permits the controller 62 to determine in real-time the maximum torque capability of each of the first and second drive wheels. Additionally, in response to the determined weight transfer between the first and second drive wheels 22-1, 22-2 the controller is configured to determine loading on each respective tire 23-1, 23-2, and, in conjunction with the friction coefficient between the subject tires and the road surface 19, to determine in real-time the maximum tractive effort of the tires 23-1, 23-2.

The determination of the tractive effort of each respective tire 23-1, 23-2 may be determined according to the “friction circle” concept illustrated in FIG. 2. The friction circle, a circle of forces, or a traction circle is a concept that is frequently used to analyze and describe the dynamic interaction between a vehicle's tire and the road surface. Typically, a diagram, such as shown in FIG. 2, is generated where a tire is viewed from above so that the road surface lies in the “x-y plane”. In such a diagram, the vehicle that the tire is attached to is generally depicted as moving in the positive “y” direction. In the diagram of FIG. 2, the vehicle 10 is shown as cornering to the right, i.e., in the positive “x” direction which points to the center of a corner being negotiated by the vehicle. The tire is rotating in a plane 78 that is at an angle 80 to a direction 82 that the tire is actually moving in. The angle 80 is termed the “slip angle” and accounts for how much the tire slides off the given course that is actually selected by the vehicle's steering 36 system.

A tire can generate a force by the mechanism of slip, which force is represented by a vector 84 in FIG. 2. The vector 84 lies in a horizontal plane where the subject tire meets the road surface. When the subject tire rolls freely, with no torque applied thereto by the vehicle's brakes or power source, the direction of vector 84 is perpendicular to the plane 78. On the other hand, when torque is being applied to the tire either by the brakes or the power source, the vector 84 will be either at an acute or at an obtuse angle with respect to the plane 78, respectively. The magnitude of vector 84 is limited by the boundary of a dashed friction circle 85, but the vector 84 may be any combination or sum of the vector's component along the x-axis and its component along the y-axis that does not exceed the boundary of the dashed circle 85. As an additional note, the diagram depicted in FIG. 2 is an idealized theoretical representation of the friction circle, for a real-world tire, the circle is likely to be closer to an ellipse, with the y-axis being slightly longer than the x-axis.

In FIG. 2, the tire is shown as generating a force component 86 along the x-axis of the force represented by a vector 84, which, when transferred by the vehicle's suspension system in combination with similar forces from the other tires, will cause the vehicle to turn to the right. Additionally, there is also a small component 88 of force in the negative y direction. This represents frictional drag between the tire and the road surface that will, if not countered by some other force, cause the vehicle to decelerate. Frictional drag of this kind is an unavoidable consequence of the mechanism of slip, by which the tire generates lateral force. The diameter of the friction circle 85, and therefore the maximum horizontal force that the tire can generate, is affected by multiple factors. Such factors may include the design properties of the tire tread and the tire's inner structure, the tire's rubber compound, the tire's condition, for example its age and temperature, quality of the road surface, and the vertical load imposed by the vehicle body on the tire through the suspension system. Accordingly, the tractive effort of a particular tire as determined by the friction circle 84 may change in real-time depending on such factors, and thereby affect the ability of the respective wheel to put the particular portion of the drive torque down to the road surface.

During operation of the vehicle 10, as the vehicle negotiates a turn or a curve, dynamic weight transfer will tend to unload the inside tire 23-1 or 23-2, i.e., the tire mounted on the wheel 22-1, 22-2 that is inside or closest to the center of the curve. In response to the inside tire being unloaded and thus experiencing reduced traction capability, the eLSD 50 will be directed to transfer a portion of the drive torque 15 to the outside drive wheel, i.e., the other of the two drive wheels 22-1, 22-2. Such transfer of a portion of the drive torque 15 to the outside wheel, will permit more of the drive torque to be transmitted to the road surface 19 through the tires 23-1 and 23-2, and thus more effectively power the vehicle 10 through the given turn.

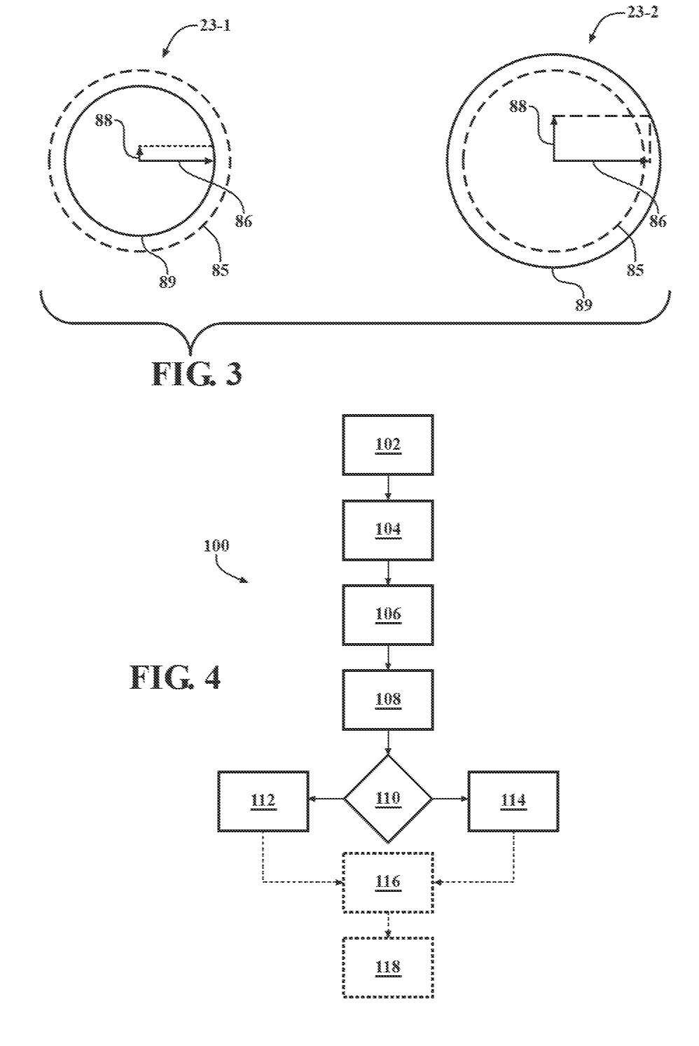

FIG. 3 represents an example of change in tractive effort of each of the tires 23-1, 23-2 due to dynamic weight transfer, such as during vehicle cornering. As shown in FIG. 3, tractive effort of the unloaded tire, in this situation tire 23-1, is decreased, while that of the tire that receives additional load from weight transfer, in this situation tire 23-2, is increased. Such a situation will typically occur when the vehicle 10 is turning to the left and the tire 23-1 mounted on the drive wheel 22-1 becomes the inside tire with respect to the center of the turn. In FIG. 3 the dashed circle 85 represents the friction circle of the particular tire in a baseline or statically loaded condition, while the solid circle 89 represents the torque capability of the same tire subject to weight transfer.

With resumed reference to FIG. 1, the vehicle 10 may additionally include a first wheel speed sensor 90 configured to detect in real-time rotational speed of the first drive wheel 22-1 and a second wheel speed sensor 92 configured to detect in real-time rotational speed of the second drive wheel 22-2. The controller 62 may then also be configured to receive the detected rotational speeds from the respective first and second wheel speed sensors 90, 92 to generate feed-back control of the eLSD 50 by comparing a desired or preprogrammed difference in speeds of the first and second drive wheels 22-1, 22-2 with actual difference thereof. The desired difference in speeds of the first and second drive wheels 22-1, 22-2 is typically zero when the vehicle 10 is traveling in a straight line, and has an appropriate magnitude for a specific turn such that there is a minimum of tire slip. However, it may also be desirable to employ a specific predetermined speed difference between the drive wheels 22-1, 22-2 to assist with controlling handling of the vehicle 10, such as via collaboration with the vehicle's stability control system (not shown).

FIG. 4 depicts a method 100 of regulating the eLSD 50 in the vehicle 10 to apportion drive torque 15 from the power source 14 between first and second drive wheels 22-1, 22-2 and transmit the drive torque to the road surface 19, as described above with respect to FIGS. 1-3. The method commences in frame 102 with the vehicle 10 being operated relative to the road surface 19, and then proceeds to frame 104. In frame 104, the method may include identifying via the controller 62 predetermined baseline portions 64 and 66 of the drive torque 15 generated by the power source 14 to be transferred by the eLSD 50 to each of the first and second drive wheels 22-1, 22-2. From frame 104, the method advances to frame 106, where the method includes determining via the controller 62 maximum torque capability of each of the first and second drive wheels 22-1, 22-2 and identifying the wheel that is capable of transmitting a greater portion and the wheel that is capable of transmitting a lesser portion of the drive torque 15 to the road surface 19.

During frame 106, the method may additionally include detecting in real-time changes in orientation of the vehicle 10 relative to the road surface 19 via at least one of the vehicle sensors 72, 74, and 76 to determine via the controller 62 the weight transfer between the first and second drive wheels 22-1, 22-2. Accordingly, based on thus determined weight transfer between the first and second drive wheels 22-1, 22-2, the controller 62 may then determine in real-time the maximum torque capability of each of the first and second drive wheels. As noted above, the vehicle's orientation may change relative to the road surface 19 in response to variation in drive torque 15 generated by the power source 14. Accordingly, the loading on each drive wheel 22-1, 22-2 and the resultant tractive effort of each tire 23-1, 23-2 may be determined as a function of change in drive torque 15 during various maneuvers of the vehicle 10, such as negotiating a turn under power.

After frame 106, the method moves on to frame 108. In frame 108, the method includes determining via the controller 62 the remaining portion of the drive torque 15 to be transferred to the drive wheel 22-1 or 22-2 that is capable of transmitting the greater portion of the drive torque by subtracting the determined maximum torque capability of the wheel capable of transmitting the lesser portion of the drive torque from the generated drive torque. Following frame 108 the method will advance to frame 110, where the method determines whether the remaining portion of the drive torque 15 is greater than the determined maximum torque capability of the more capable wheel.

If in frame 110 it is determined that the remaining portion of the drive torque 15 is greater than the determined maximum torque capability of the more capable wheel, the method proceeds to frame 112. In frame 112 the method includes regulating the eLSD 50 via the controller 62 to transfer the portion of the drive torque 15 that is equal to the maximum torque capability of the drive wheel 22-1 or 22-2 that is capable of transmitting the greater portion of the drive torque. On the other hand, if in frame 110 it is determined that the remaining portion of the drive torque 15 is not greater, i.e., is equal to or less, than the determined maximum torque capability of the more capable wheel, the method will proceed from frame 108 to frame 114. In frame 114, the method includes regulating the eLSD 50 via the controller 62 to transfer the determined remaining portion 70 of the drive torque 15 to the drive wheel 22-1 or 22-2 that is capable of transmitting the greater portion of the drive torque.

Additionally, following either frame 112 or 114 the method may advance to frame 116. In frame 116 the method includes receiving via the controller 62 rotational speeds from the respective first and second wheel speed sensors 90, 92. Furthermore, from frame 116 the method may proceed to frame 118. In frame 118 the method includes generating feed-back control of the eLSD 50 via the controller 62 by determining an actual difference in speeds of the first and second drive wheels 22-1, 22-2 and then comparing a desired speed difference between the drive wheels with the actual speed difference there between.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A motor vehicle comprising:
a power source configured to generate drive torque;
a first drive wheel and a second drive wheel for transmitting the drive torque to a road surface;
an electronic limited slip differential (eLSD) operatively connected to the power source and configured to apportion the drive torque between the first and second drive wheels; and
a controller configured to:
determine maximum torque capability of each of the first and second drive wheels and identify the wheel that is capable of transmitting a greater portion and the wheel that is capable of transmitting a lesser portion of the drive torque to the road surface;
determine a remaining portion of the drive torque by subtracting the determined maximum torque capability of the wheel capable of transmitting the lesser portion of the drive torque from the generated drive torque;
regulate the eLSD to transfer to the wheel that is capable of transmitting the greater portion of the drive torque a portion of the drive torque that is equal to the maximum torque capability of the more capable wheel if the remaining portion of the drive torque is greater than the determined maximum torque capability of the more capable wheel; and
regulate the eLSD to transfer to the wheel that is capable of transmitting the greater portion of the drive torque the determined remaining portion of the drive torque if the remaining portion of the drive torque is equal to or less than the determined maximum torque capability of the more capable wheel.

2. The vehicle of claim 1, further comprising at least one vehicle sensor configured to detect, in real-time, changes in orientation of the vehicle relative to the road surface, and wherein the controller receives signals from the at least one vehicle sensor to determine the maximum torque capability of each of the first and second drive wheels.

3. The vehicle of claim 2, wherein the at least one vehicle sensor includes a lateral acceleration sensor, a longitudinal acceleration sensor, and a yaw sensor, and in response to the received signals from the lateral acceleration, longitudinal acceleration, and yaw sensors the controller determines weight transfer between the first and second drive wheels to determine, in real-time, the maximum torque capability of each of the first and second drive wheels.

4. The vehicle of claim 3, wherein each of the first and second drive wheels includes a pneumatic tire that establishes tractive effort with respect to the road surface, and wherein in response to the determined weight transfer between the first and second drive wheels the controller is configured to determine loading on each respective tire to determine, in real-time, a maximum tractive effort thereof.

5. The vehicle of claim 4, wherein the determination of the tractive effort of each respective tire is determined via the “friction circle” concept according to physical properties of and a vertical load on the subject tire.

6. The vehicle of claim 1, wherein the eLSD includes a friction plate clutch and the controller is configured to regulate engagement of the clutch to apportion the drive torque between the first and second drive wheels.

7. The vehicle of claim 1, further comprising a first wheel speed sensor configured to detect, in real-time, a rotational speed of the first drive wheel and a second wheel speed sensor configured to detect, in real-time, a rotational speed of the second drive wheel, and wherein the controller is additionally configured to receive the detected rotational speeds from the respective first and second wheel speed sensors to generate feed-back control of the eLSD by comparing a desired difference in speeds of the first and second drive wheels with actual difference thereof.

8. A method of regulating an electronic limited slip differential (eLSD) in a motor vehicle to apportion drive torque from a power source between first and second drive wheels and transmit the drive torque to a road surface, the method comprising:
determining maximum torque capability of each of the first and second drive wheels and identifying the wheel that is capable of transmitting a greater portion and the wheel that is capable of transmitting a lesser portion of the drive torque to the road surface;
determining a remaining portion of the drive torque by subtracting the determined maximum torque capability of the wheel capable of transmitting the lesser portion of the drive torque from the generated drive torque;
regulating the eLSD to transfer to the wheel that is capable of transmitting the greater portion of the drive torque a portion of the drive torque that is equal to the maximum torque capability of the more capable wheel if the remaining portion of the drive torque is greater than the determined maximum torque capability of the more capable wheel; and
regulating the eLSD to transfer to the wheel that is capable of transmitting the greater portion of the drive torque the determined remaining portion of the drive torque if the remaining portion of the drive torque is equal to or less than the determined maximum torque capability of the more capable wheel.

9. The method of claim 8, further comprising detecting in real-time changes in orientation of the vehicle relative to the road surface via at least one vehicle sensor to determine the maximum torque capability of each of the first and second drive wheels.

10. The method of claim 9, wherein the at least one vehicle sensor includes a lateral acceleration sensor, a longitudinal acceleration sensor, and a yaw sensor, further comprising determining weight transfer between the first and second drive wheels in response to the received signals from the lateral acceleration, longitudinal acceleration, and yaw sensors to determine in real-time the maximum torque capability of each of the first and second drive wheels.

11. The method of claim 10, wherein each of the first and second drive wheels includes a pneumatic tire that establishes tractive effort with respect to the road surface, and further comprising determining loading on each respective tire to determine in real-time a maximum tractive effort thereof in response to the determined weight transfer between the first and second drive wheels.

12. The method of claim 11, wherein the determination of the tractive effort of each respective tire is determined via the “friction circle” concept according to physical properties of and a vertical load on the subject tire.

13. The method of claim 11, wherein each of said determining the maximum torque capability of each of the first and second drive wheels, determining the remaining portion of the drive torque, regulating the eLSD, detecting in real-time changes in orientation of the vehicle, determining weight transfer between the first and second drive wheels, and determining loading on each respective tire is accomplished via a controller.

14. The method of claim 13, wherein the vehicle additionally includes a first wheel speed sensor configured to detect in real-time rotational speed of the first drive wheel and a second wheel speed sensor configured to detect in real-time rotational speed of the second drive wheel, and further comprising receiving via the controller the detected rotational speeds from the respective first and second wheel speed sensors and generating feed-back control of the eLSD by comparing a desired difference in speeds of the first and second drive wheels with actual difference thereof via the controller.

15. The method of claim 13, wherein the eLSD includes a friction plate clutch, further comprising regulating engagement of the clutch to apportion the drive torque between the first and second drive wheels via the controller.

16. A method of regulating an electronic limited slip differential (eLSD) in a motor vehicle to apportion drive torque from a power source between first and second drive wheels and transmit the drive torque to a road surface, the method comprising:
detecting, in real-time, changes in orientation of the vehicle relative to the road surface via at least one vehicle sensor;
receiving via the controller the detected changes in orientation of the vehicle;
determining via the controller in response to the detected changes in orientation of the vehicle the maximum torque capability of each of the first and second drive wheels;
identifying via the controller the wheel that is capable of transmitting a greater portion and the wheel that is capable of transmitting a lesser portion of the drive torque to the road surface;
determining via the controller a remaining portion of the drive torque by subtracting the determined maximum torque capability of the wheel capable of transmitting the lesser portion of the drive torque from the generated drive torque;
regulating via the controller the eLSD to transfer to the wheel that is capable of transmitting the greater portion of the drive torque a portion of the drive torque that is equal to the maximum torque capability of the more capable wheel if the remaining portion of the drive torque is greater than the determined maximum torque capability of the more capable wheel; and
regulating via the controller the eLSD to transfer to the wheel that is capable of transmitting the greater portion of the drive torque the determined remaining portion of the drive torque if the remaining portion of the drive torque is equal to or less than the determined maximum torque capability of the more capable wheel.

17. The method of claim 16, wherein the at least one vehicle sensor includes a lateral acceleration sensor, a longitudinal acceleration sensor, and a yaw sensor, further comprising determining weight transfer between the first and second drive wheels in response to the received signals from the lateral acceleration, longitudinal acceleration, and yaw sensors to determine, in real-time, the maximum torque capability of each of the first and second drive wheels.

18. The method of claim 17, wherein each of the first and second drive wheels includes a pneumatic tire that establishes tractive effort with respect to the road surface, and further comprising determining loading on each respective tire to determine, in real-time, according to the “friction circle” concept a maximum tractive effort thereof in response to the determined weight transfer between the first and second drive wheels and according to physical properties of and a vertical load on the subject tire.

19. The method of claim 16, wherein the vehicle additionally includes a first wheel speed sensor configured to detect, in real-time, a rotational speed of the first drive wheel and a second wheel speed sensor configured to detect, in real-time, a rotational speed of the second drive wheel, and further comprising receiving via the controller the detected rotational speeds from the respective first and second wheel speed sensors and generating feed-back control of the eLSD by comparing a desired difference in speeds of the first and second drive wheels with actual difference thereof via the controller.

20. The method of claim 16, wherein the eLSD includes a friction plate clutch, further comprising regulating engagement of the clutch to apportion the drive torque between the first and second drive wheels via the controller.
